(19) United States
(12) Patent Application Publication
(10) Pub. No.: US 2007/0250391 A1
(43) Pub. Date: Oct. 25, 2007

(54) Merchandising system and method for food and non-food items for a meal kit

(76) Inventors: Hendrik D. Prade, Langenpreising (DE); Lawrence R. Wills, Parkton, MD (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/397,901

(22) Filed: Apr. 5, 2006

(51) Int. Cl. G06Q 20/00

(52) U.S. Cl. 705/16

(57) ABSTRACT

The present invention is a merchandising system and method for the organized display, selection and purchase of products, particularly, food and non-food items for a meal kit, which can be customized to the taste and size preferences of the consumer. The system comprises a display apparatus, a plurality of food items, a food item identification and selection guide and a take-away bag. The display apparatus, food items, and food item identification and selection guide utilize indicia (for example, colors) to assist the consumer in the identification and selection of food items to create a customized meal having a protein, seasoning or sauce, starch and vegetable.

### BACKGROUND OF THE INVENTION

1. Field of the Invention

The present invention relates to a merchandising system and method for the organized display, selection and purchase of products, particularly, food and non-food items for a meal kit.

2. Background Art

The busy household and lifestyle of today's consumer often makes planning, shopping for, and preparing a meal a daunting, inconvenient and time-consuming task. Deciding on a meal, shopping for the required ingredients, and preparing the meal alone can take two to three hours, assuming that the consumer has at least some familiarity with food products, grocery stores and cooking. This does not account for the time to travel to and from the grocer, nor for clean-up after preparation and consumption of the meal.

Furthermore, it can be challenging to select and prepare a meal in the home that appeals to all tastes, dietary preferences and restrictions, so consumers often resort to the preparation of different dishes (or variations on the same dish) to appease all eaters, resulting in the purchase of more or different ingredients than what is required by a single recipe. This, too, can be expensive and may result in a waste of ingredients or prepared dishes that cannot be consumed prior to spoiling. Moreover, the packaging of many food items at the grocer is simply too large for a household of two or less, again, ultimately resulting in the waste of food and money.

While dining out at a restaurant obviates the need to shop for and prepare a meal, dining out can be expensive and still consume hours of time. In an effort to reduce the time devoted to preparation and consumption of a meal, fast-food restaurants offer standard, broad-appeal food items to consumers (such as, hamburgers, french fries, sandwiches, fried chicken, etc.) that require minimal time to prepare and serve. The food items can be purchased a la carte or together as a meal, and can be consumed on the premises or taken to another location. While the fare offered at fast-food restaurants is prepared and served quickly, it is not always healthy or good-tasting, and cannot be customized to any great extent to accommodate the taste preferences and dietary restrictions of consumers. Furthermore, the fare at fast-food restaurants can be just as expensive as that offered at other sit-down restaurants or delicatessens.

One way to reduce the effort and time associated with daily meal preparation, while still accommodating personal taste preferences, dietary restrictions and meal versatility, is to employ a personal chef. Under a personal chef arrangement, the chef meets with the client weekly, bi-weekly or monthly to prepare a customized menu of gourmet packaged meals based on the personal preferences of, and number of individuals in, the client's household. The prepared meals are wrapped, vacuum sealed, labeled and refrigerated or frozen by the personal chef for consumption at a later time/date. To prepare the meals for consumption, the client simply refers to the labels on the meal items for heating and serving instructions. Some personal chefs employ a colorized labeling system to indicate which prepared menu items are for which meal. For example, items affixed with a blue label are for breakfast, items affixed with a green label are for lunch, while items affixed with a red label are for dinner. Appetizers and other food items (such as, snack items or desserts) bear still other colored labels. While employment of a personal chef allows for the advanced preparation of good-tasting, customized, appropriately-portioned meals, the services of a personal chef can be expensive and do not necessarily allow for last minute substitutions, if the client does not care to eat an item prepared and packaged to accompany a particular meal.

With advancements in food packaging and processing technology, food manufacturers have attempted to provide consumers with food and meal products that are inexpensive, shelf-stable or shelf-life extended, and easy to prepare and serve. One such example is the “frozen dinner” or meal that consists of individual portions of a vegetable, starch and protein (and, in some instances, dessert) provided in a sectioned tray or container. In other instances, the meal is an entree, such as a single-serving of pizza, ravioli or meatloaf. The meal is removed from the package, heated in a conventional oven or microwave, and served in the same sectioned tray or container in which it was heated. While frozen meals can be economical, time-saving and easy to prepare, overall taste and food quality may be compromised as a result of the freezing process, and multiple meals must be purchased to feed an entire family. Moreover, the frozen meal affords the consumer little opportunity to customize the meal to meet his or her personal preferences, as the vegetable, starch and protein have been pre-selected by the food manufacturer and cannot be “changed-out” prior to purchase.

Another attempt by food manufacturers to help the consumer with meal preparation is the “meal kit”. One such example is the Lunchables® meal kit consisting of single-serving portions of luncheon meats, cheese and crackers packaged in a plastic tray. Although this meal kit is appealing to children and requires no heating or other pre-service preparation, it is somewhat expensive, lacks a nutritious vegetable item, and does not have a long shelf-life.

Still another meal kit idea developed by food manufacturers is the shelf-stable “dinner mix” or “skillet dinner”. A dry dinner mix provides an entree sized to serve four to six people, and consists primarily of a starch (e.g., pasta or rice) and a seasoning or sauce packet. Water and a protein and/or vegetable is added to the mix to complete the entree. Dinner mixes and skillet dinners are also available in frozen form, but still require the addition of other ingredients to complete the meal. While dinner mixes have a long shelf-life and are sized to feed an entire family, such mixes lack the taste and quality of a freshly-prepared meal, and tend to be high in sodium and preservatives.

Of course, it is possible to separately purchase vegetables, starches, meats, entrees and other food items at a grocery store (either fresh, frozen, canned or vacuum packed), to create and prepare a complete meal suited to the preferences of the consumer and his or her household. Such items, however, may be inappropriately sized for the consumer's needs and the consumer may not know how to identify, select and prepare food items that best compliment each other for a tasty and “harmonious” meal. This type of meal creation also requires that the consumer go to different areas of the grocery store for different items (that may not be compatibly sized or processed in terms of manufacture), which can consume a significant amount of the consumer's time.

To save consumers the time and trouble of traveling up and down a store aisle in search of desired products, some manufacturers consolidate products in a single display apparatus, to facilitate the location and selection of products by the consumer. One such example is the merchandise display system of U.S. Pat. No. 5,797,755 to Montgomery (the Montgomery patent). The Montgomery patent discloses a merchandise display system for related types of products in which each product is provided with a package bearing an icon indicating the type of product and its intended use, and an indicia of the quality of the product. The display is further provided with panels setting forth the icons and literal descriptions thereof (i.e., a legend). The panels allow for the arrangement of product packages in rows and columns based on the icon and indicia of quality on each package. The utility of the display apparatus of the Montgomery patent has been described with respect to hair brushes and combs of different qualities and intended use.

While the Montgomery patent describes an apparatus useful for the arrangement and display of hair brushes and combs that effectively communicates information regarding such products to the consumer, the apparatus cannot provide for the display of perishable items (such as food), nor educate the consumer on how one item of the display relates to the others for appropriate or complimentary product selections.

Thus, in the food processing and preparation field, a need exists for a meal kit merchandising system having food, beverage and/or other items that are easy to identify, select and prepare for consumption, and that can be purchased in portions and sizes appropriate to the consumer or consumer's household. The need also exists for a merchandising system that enables the consumer to individually select or customize the components or items of a meal (i.e., appetizer, soup, vegetable, starch, protein, entree, dessert, seasoning, and/or beverage) to suit the consumer's taste preferences. Another need exists for a meal kit that has a relatively long shelf-life, but has the taste, quality, color and texture of freshly prepared food and ingredients. Still another need exists for a meal kit providing food having restaurant quality taste, without a restaurant menu price.

A need also exists for a meal kit merchandising method to display food and non-food items, and to communicate information to the consumer to allow for the selection of items to create wholly customized meals. Such information may include: (1) type of food item, (2) quality of food item, (3) serving or portion size, (4) food item preparation instructions, and (5) food item serving suggestions or recipes.

Still another need exists for an apparatus that enables all available food and non-food items of a meal kit to be merchandised and displayed at a single location in a retail establishment or other vending area, for customized selection and purchase by a consumer.

### BRIEF SUMMARY OF THE INVENTION

In accordance with the above described needs and objectives, in one embodiment the present invention is a merchandising method for the organization and display of items for creating a customized meal kit. The method comprises the steps of providing a display apparatus, providing packaged protein food items having a first indicia of the type of food item imprinted thereon, providing packaged starch food items having a second indicia of the type of food item imprinted thereon, providing packaged vegetable food items having a third indicia of the type of food item imprinted thereon, providing an item identification and selection guide for creating the meal kit and having a representation of the steps for identifying and selecting the food items for creating the meal kit, the steps corresponding to the first indicia of the protein food items, the second indicia of the starch food items, and the third indicia of the vegetable food items, and organizing and displaying the protein food items, starch food items and vegetable food items in the display apparatus, such that all of the protein food items having the first indicia are displayed in a first area of the display apparatus, all of the starch food items having the second indicia are displayed in a second area of the display apparatus, and all of the vegetable food items having the third indicia are displayed in a third area of the display apparatus.

The first indicia of the protein food items may comprise a first color, the second indicia of the starch food items may comprise a second color, and the third indicia of the vegetable food items may comprise a third color. The representation of steps for identifying and selecting the items for creating the meal kit may correspond to the first color, second color and third color of the first indicia, second indicia and third indicia.

The first area of the display apparatus may be colored to correspond to the first color of the first indicia, the second area of the display apparatus may be colored to correspond to the second color of the second indicia, and the third area of the display apparatus may be colored to correspond to the third color of the third indicia.

The steps for identifying and selecting food items for creating the meal kit may comprise the steps of identifying a protein food item by referring to the first indicia imprinted on the protein food item and the item identification and selection guide, selecting a protein food item, identifying a starch food item by referring to the second indicia imprinted on the starch food item and the item identification and selection guide, selecting a starch food item, identifying a vegetable food item by referring to the third indicia imprinted on the vegetable food item and the item identification and selection guide, and selecting a vegetable food item.

In another embodiment, the present invention is a merchandising method for the organization and display of items for creating a customized meal kit, comprising the steps of providing a display apparatus, providing a plurality of types of food items, each of said types of food items having indicia of the types of food items printed thereon, providing an item identification and selection guide having a representation of steps for identifying and selecting the types of food items from the plurality of types of food items to create the meal kit, the steps corresponding to the indicia of the types of food items, and organizing and displaying the plurality of types of food items in the display apparatus.

In yet another embodiment, the present invention is a meal kit merchandising system for creating a meal kit comprising a display apparatus, at least two types of packaged food items, the first type of food item having a first type of food item indicia for identifying the first type of food item and the second type of food item having a second type of food item indicia for identifying the second type of food item, and a food item identification and selection guide for identifying and selecting food items to create the meal kit.

### BRIEF DESCRIPTION OF THE DRAWINGS/FIGURES

FIG. 1 is a perspective view of one embodiment of a merchandising system and display apparatus of the present invention;

FIG. 2 is a front view of one embodiment of an item package of the present invention;

FIG. 3 is a back view of the item package of FIG. 2;

FIG. 4 is a flowchart of a merchandising method of the present invention;

FIG. 4A is a flowchart of the steps for identifying and selecting food items of the method of FIG. 4;

FIG. 5 is an alternative embodiment of a merchandising system and display apparatus of the present invention;

FIG. 6 is an enlarged view of the item identification and selection guide of the display apparatus of FIG. 5;

FIG. 7 is another embodiment of a food item package, particularly, a protein food item package, of the merchandising system of FIG. 5;

FIG. 8 is an embodiment of a seasoning or sauce food item package of the merchandising system of FIG. 5;

FIG. 9 is an embodiment of a starch food item package of the merchandising system of FIG. 5;

FIG. 10 is an embodiment of a vegetable food item package of the merchandising system of FIG. 5;

FIG. 11 is an embodiment of a take-away bag containing the food items of the merchandising system of FIG. 5; and

FIG. 12 is perspective view of the display apparatus of FIG. 1 positioned within an embodiment of a food preparation and service station of the present invention.

### DETAILED DESCRIPTION OF THE INVENTION

The present invention relates to a merchandising system and method for the organized display, selection and purchasing of food and non-food items for a customizable meal kit. The system and method of the present invention, optionally, provides for preparation of meal kit food items, when the merchandising system is employed in a retail establishment or other area where food can be prepared and consumed. Preferred embodiments of the present invention will now be described. While specific configurations, arrangements and steps have been described, it should be understood that such discussion is for illustrative purposes only. A person skilled in the relevant art will recognize that other configurations, arrangements and steps can be employed without departing from the spirit and scope of the present invention. It will also be apparent to those skilled in the relevant art that the present invention can be utilized with products other than food and non-food items intended for use as a meal kit.

For description purposes, a “meal kit” refers to one or a combination of selected food and/or non-food items employed in the creation, preparation and consumption of a meal. While a meal kit ideally comprises more than one food item, a “meal” may consist solely of a single item and may be consumed as any meal of the day (e.g., as breakfast, brunch, lunch, dinner or snack).

An “item” refers to a food and/or non-food item. A “food item” refers to any finished edible product or ingredient for an edible product, including vegetables, starches, breads, proteins (meats, poultry, pork, fish and seafood), carbohydrates, dietary fibers, seasonings, appetizers, desserts, beverages (including water) and seasonings or sauces. A “non-food” item refers to serving or preparation implements such as plates, trays, cups, bowls, napkins, cellophane wraps, foils, bags and utensils (such as knives, spoons, forks and seafood picks and crackers).

The term “indicia” may refer to any color, picture, graphic, textual matter (i.e., words, letters, numbers and/or combinations thereof), pattern, texture or other symbol or marking capable of conveying information or meaning to the consumer.

Further, the meal kit of the present invention may comprise food items that are fresh, frozen, sub-par or par cooked, vacuum packed, canned, hydrostatic pressure processed (“HPP”) or any combination thereof. In accordance with the objectives of the present invention, and in one embodiment thereof, the food items of the meal kit are (1) fresh, sub-par or par cooked, (2) shelf-life extended by hydrostatic pressure processing, and (3) refrigerated, to provide food items of the meal kit with an extended shelf-life, depending on the food item. Hydrostatic pressure processing is preferred, in that it gives the food item an extended, refrigerated shelf life, while eliminating bacteria and micro-organisms, and preserving the taste, color, texture and quality of the food item. A preferred hydrostatic pressure processing method for food, particularly seafood, is described and claimed in U.S. application Ser. No. ______, filed Apr. 5, 2006, to Love et al. (the “Love application”), the disclosure of which is incorporated herein, in its entirety, by reference.

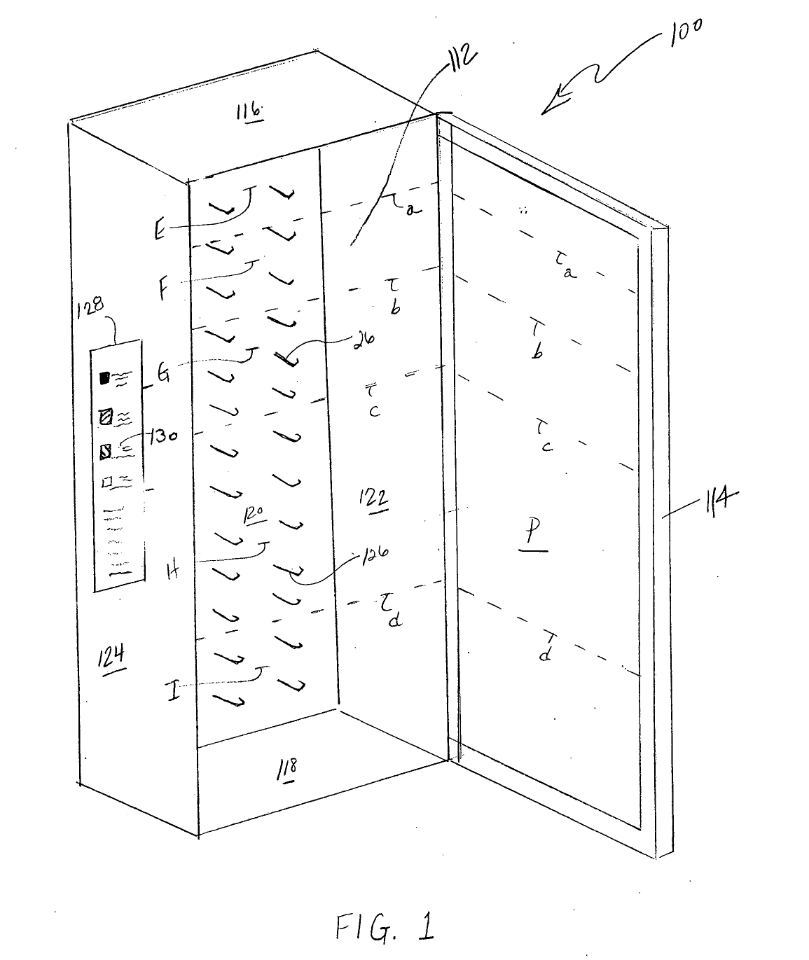

In a first embodiment, the meal kit merchandising system of the present invention comprises a display apparatus, packaged food and non-food items, and an item identification and selection guide. With reference now to the drawings forming a part hereof, FIG. 1 illustrates a merchandising display apparatus 100 of the present invention. In this embodiment, display apparatus 100 is an upright refrigerator case having a refrigerated compartment 112 and a door 114 shown in the open position. Door 114 is preferably provided with a glass panel P or other type of see-through material to permit the consumer to visualize items contained within refrigerated compartment 112. While a refrigerator case is shown in FIG. 1, it should be realized by those skilled in the art that display apparatus 100 may also take the form of a freezer, a refrigerated wall unit, a peg-board panel, vertically arranged shelving or other apparatus known in the art of product merchandising display, so long as such apparatus meets the requirements for maintaining and displaying the subject item(s).

Refrigerated compartment 112 is formed by top, bottom, back, left-side and right-side walls 116, 118, 120, 122, 124. Back wall 120 is provided with a series of pegs or hooks 126 arranged in rows and columns to receive the packaged food and, optionally, non-food items of the present invention.

In an alternative embodiment, refrigerated compartment 112 and/or door 114 may be segmented into multiple compartments or sections, as at dashed lines a, b, c, d, to form discrete compartments or sections E, F, G, H, I, each of which receive a particular type of item. For the meal kit of the present invention, for example, the pegs of compartment E would receive food items categorized as appetizers, the pegs of compartment F would receive food items categorized as vegetables, the pegs of compartment G would receive food items categorized as starches, the pegs of compartment H would receive food items categorized as proteins (e.g., beef, pork, poultry, fish or seafood) or entrees, and the pegs of compartment I would receive food items categorized as desserts. Bottom wall 118 of refrigerated compartment 112 could be configured to receive items in lidded, round containers or cans not suitable for hanging, such as soups, sauces, or pasteurized crab meat, for example. If refrigerated compartment 112 has been segmented into multiple compartments as described above, not all of the compartments need be refrigerated, if the items of the segmented compartments do not require refrigeration. Indeed, some of the segmented compartments may be climate-controlled (e.g., refrigerated) while others are not, depending on the nature of the food and non-food items to be displayed within the segmented compartments. For example, it would not be necessary to refrigerate breads, dry seasoning packets or take-away bags.

Moreover, while display apparatus 100 of FIG. 1 is shown having five compartments, and two columns and thirteen rows of pegs 126, it should be understood by those skilled in the art that display apparatus 100 may be configured to provide any number of compartments and any number of pegs (configured in any type of row and column arrangement), depending on the quantity and type of items to be displayed.

Positioned on or affixed to the exterior of right-side wall 124 is an item identification and selection guide 128 that provides, among other things, a legend 130 (unintelligible characters) for the indicia appearing on the item packaging, to be described in greater detail below. Item identification and selection guide 128, together with item packaging indicia, conveys information to the consumer to assist in the identification, selection, preparation and service of items of the meal kit. Item identification and selection guide 128 further provides a representation of steps for identifying and selecting food items of the meal kit, wherein the steps correspond to the indicia of the food items to provide the consumer with step-by-step instructions for identifying and selecting food items to create a customized meal. The representation is discussed in further detail below.

While item identification and selection guide 128 is shown affixed to the right-side wall of display apparatus 100, it should be understood by the skilled artisan that item identification and selection guide 128 may be positioned on left-side wall 122, top 116, door 114 or on any type of signage positioned proximate to, in or on display apparatus 100, so long as it is within view of the consumer.

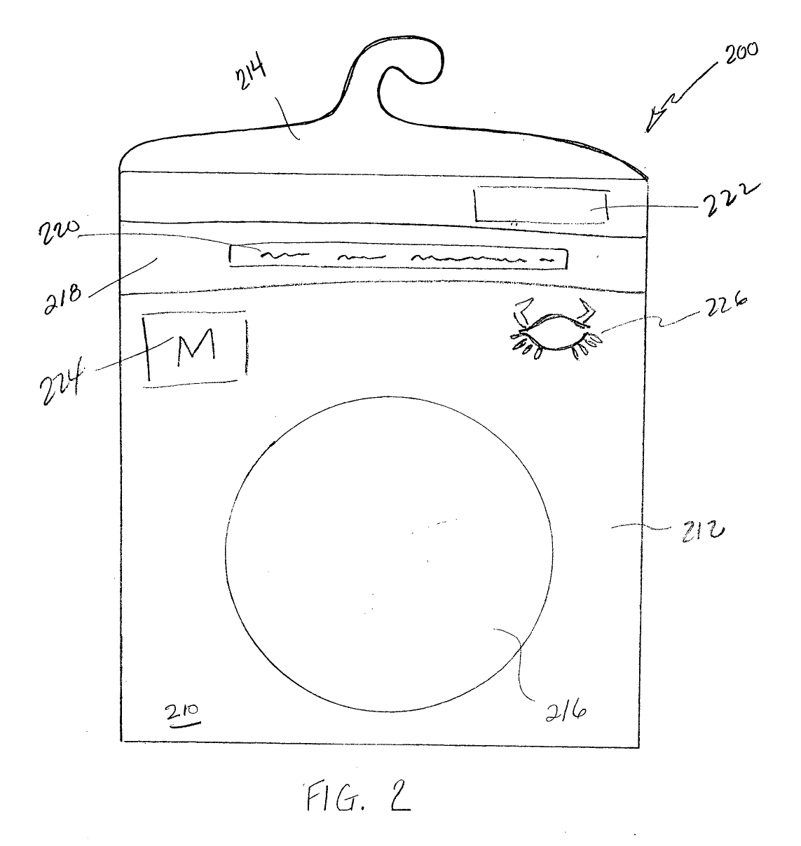

FIG. 2 is a front view of an item package 200, which may contain a food item of the present invention. Front 210 of item package 200 comprises a main body portion 212 and a hanger 214. Main body portion 212 and hanger 214 are preferably formed from cardboard having a thickness and properties suitable for the purposes of the present invention. For example, for the packaging of refrigerated food items, item package 200 may be formed from wax-coated cardboard to withstand the humidity of a refrigerated display case. Alternatively, hanger 214 may be molded from plastic and attached to item package 200 by a suitable attachment mechanism for processed food items. Naturally, other materials that meet the objectives of the present invention or the specific requirements of the item or product to be packaged may be used for item package 200. Item package 200 has no set dimensions and may be sized and shaped to accommodate the food item packaged therein.

Main body portion 212 may be provided with an item containment area 216, to which a processed and sealed food item is attached. Like item package 200, item containment area 216 has no set dimension, and may be sized and shaped to accommodate the food item contained therein. For example, if the item is a single serving of lemon pepper chicken, item containment area 216 is sized and configured to accommodate a sealed chicken breast weighing 3 to 6 ounces. If the item is a “family-size” package of crab cakes, item containment area 216 is sized and configured to accommodate six sealed crab cakes weighing approximately 3 ounces each.

The food item may be attached to item containment area 216 by any suitable adhesive or fastening mechanism known in the food packaging art.

Front side 210 is imprinted with indicia, which conveys information to the consumer about the specific food item of the item package. In one embodiment of the present invention, a first front-side indicia 218 denotes the type of food item, e.g., an appetizer food item, a soup food item, a protein food item, a seasoning or sauce food item, a starch food item, a vegetable food item, or a dessert food item. In one embodiment of the invention, first front-side indicia 218 is a colored band having a width of approximately one inch that extends from the left side of item package 200 to the right side. The first front-side indicia is colored to correspond to a type of food item, so that each type (or category) of food item has its own specific color. More particularly, and for example, an appetizer food item may be colored blue, a soup food item may be colored orange, a protein food item may be colored black, a seasoning or sauce food item may be colored red, a starch food item may be colored yellow, a vegetable food item may be colored green and a dessert food item may be colored white. Naturally, other colors or types of indicia (e.g., patterns or pictorial images) may be used to denote the type or category of food item of the item package.

Front side 210 may further comprise a second front-side indicia 220 that indicates the exact name of the food item, e.g., broccoli rabe and baby carrots, lemon pepper chicken, flounder stuffed with deviled crab, etc. In this instance, second front-side indicia 220 may comprise alpha characters or text (shown as unintelligible characters in FIG. 2) to indicate the exact name of the processed food item to the consumer.

Front side 210 may further comprise a food item source identifier 222 to convey manufacturer branding information to the consumer. More particularly, food item source identifier 222 may consist of the manufacturer's trademark or other source identifying matter.

Front side 210 item package 200 may further comprise indicia of the number of servings per container of the food item, shown at 224, in FIG. 2. For example, the letters S, M, L and XL could be employed to convey information on servings per container to the consumer. In this instance, for example, S (meaning “Small”) would provide one serving, M (meaning “Medium”) would provide two servings, L (meaning “Large”) would provide four servings, and XL (meaning “Extra Large) would provide the appropriate number of servings for a large family or party. Alternatively, numbers (such as 1, 2, 4, 6) or other letters could be employed as servings per container indicia to convey such information to the consumer. Regardless of what is employed as the servings per container indicia, it is envisioned that the legend for servings per container indicia 224 may be printed on item identification and selection guide 128 to assist the consumer in identifying and selecting the appropriately sized food item for his or her needs.

Still other indicia may be employed on front-side 210 of item package 200 to convey information to the consumer. For example, to further assist the consumer in distinguishing among the offerings of protein food items, the present invention provides a pictorial indicia to indicate if the protein food item is primarily beef, pork, chicken, fish or crab. A pictorial type of protein food indicia is shown at 226 in FIG. 2, to indicate that the type of protein food item of the item package is primarily crab. Other pictorial type of protein food indicia could include a graphic of a pig for pork, a cow for beef, a chicken for poultry, and a fish for seafood. A legend for the pictorial indicia could also be included on item identification and selection guide 128, to educate the consumer on the same.

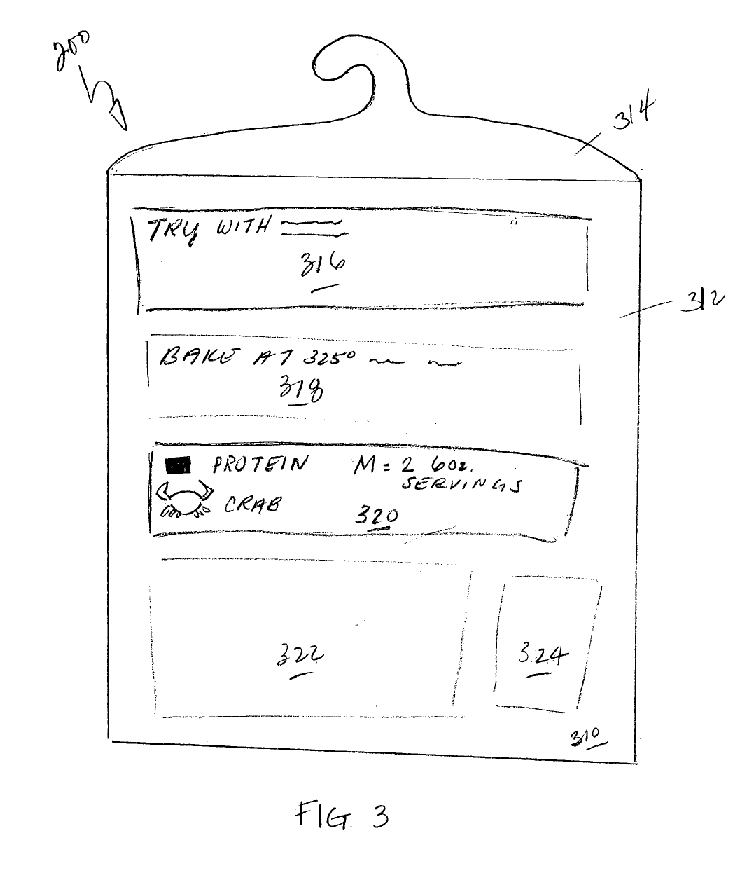

FIG. 3 is a back view of item package 200 of FIG. 2. The profile of back 310 of item package 200 is a mirror image of front 210. Like front 210, back 310 comprises a main body portion 312 (that may be the back side of main body portion 212) and a hanger 314 (that may be the back side of hanger 214). Back side 310 is imprinted with additional indicia that conveys information to the consumer about the item contained in item package 200. In one embodiment of the present invention, and where item package 200 contains a food item, a first back-side indicia 316 may provide recommendations on other food items to be prepared and served with the item of the package (e.g., recommended starch and vegetable accompaniments or side dishes for a particular protein) or recipes and serving suggestions, to create a high-quality, good tasting meal where the ingredients and flavors are complimentary.

A second back-side indicia 318 provides food handling and preparation instructions, including information on times and temperatures for cooking a food item. Indicia 318 may also specify the preferred tools, implements and pots or pans for preparing, cooking and serving the food item.

A third back-side indicia 320 may provide an item package legend (corresponding to the legend of item identification and selection guide 128) that explains the indicia printed on front side 210 and specific to the item contained in item package 200, for the quick reference of the consumer.

A fourth back-side indicia 322 may provide information on the ingredients of the item contained within item package 200, while a fifth back-side indicia 324 may provide manufacturer information and other food labeling requirements including, but not limited to, packaging and sell-by dates. It should be understood that while five back-side indicia have been described, any number of indicia could be provided to convey any type of information to the consumer. Similarly, the back-side indicia may be printed on back side 310 of item package 200 in an arrangement other than that shown in FIG. 3 to achieve the information conveying objectives associated with the item or on front side 210 and vice versa.

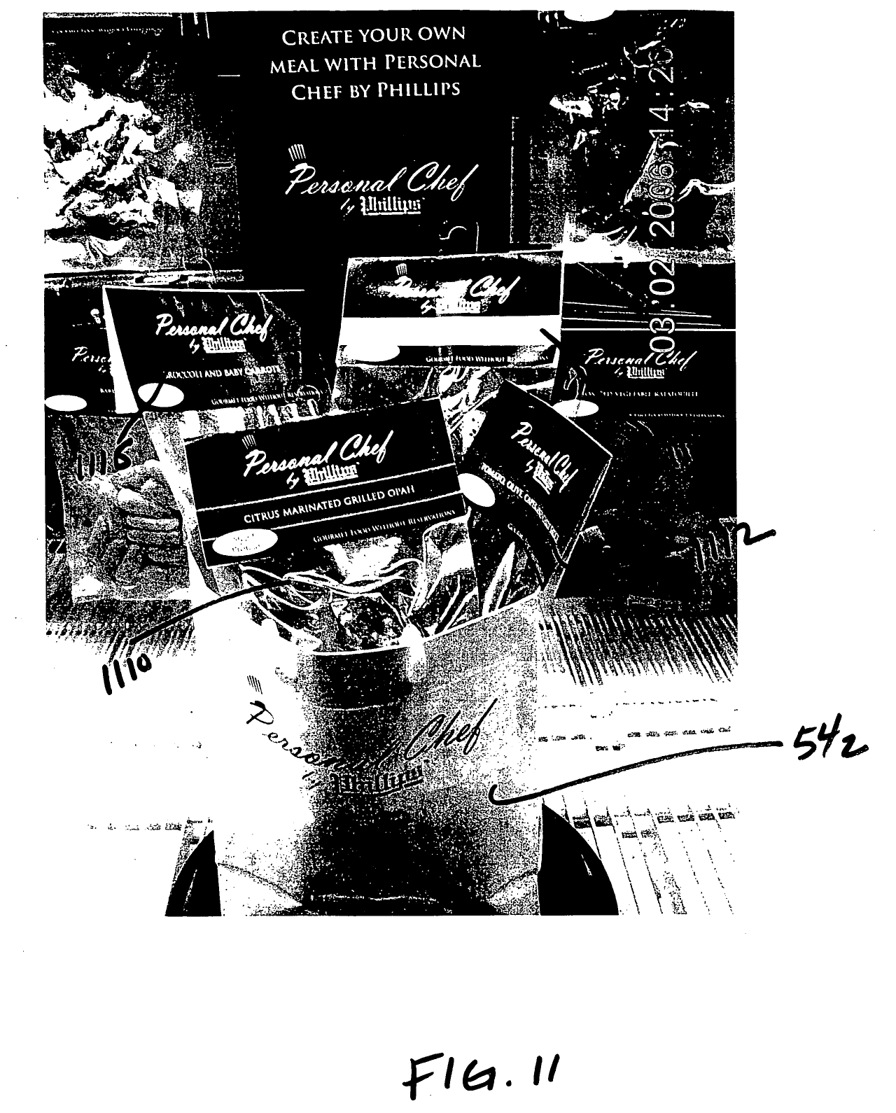

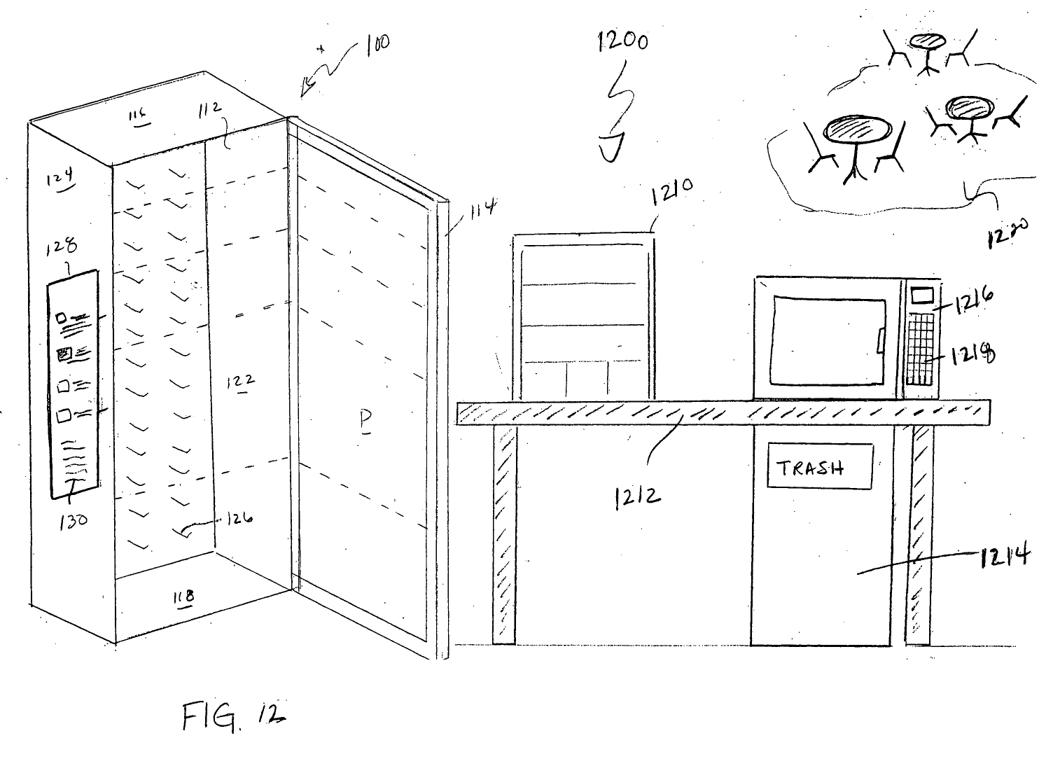

The present invention also provides for non-food items for selecting, preparing, serving and consuming the food items of the present invention. More particularly, the non-food items may comprise take-away bags and disposable plates, cups, heating trays, serving trays, knives, forks, spoons, seafood picks and crackers, and napkins. The non-food items of the present invention can be displayed in a rack or other apparatus positioned proximate to display apparatus 100, in display apparatus 100 or in an apparatus affixed to display apparatus 100. Depending on the nature of the food items displayed in display apparatus 100, other non-food items for preparing, serving and consuming the food items are contemplated. The non-food items of the present invention are discussed again, with respect to FIGS. 11 and 12.

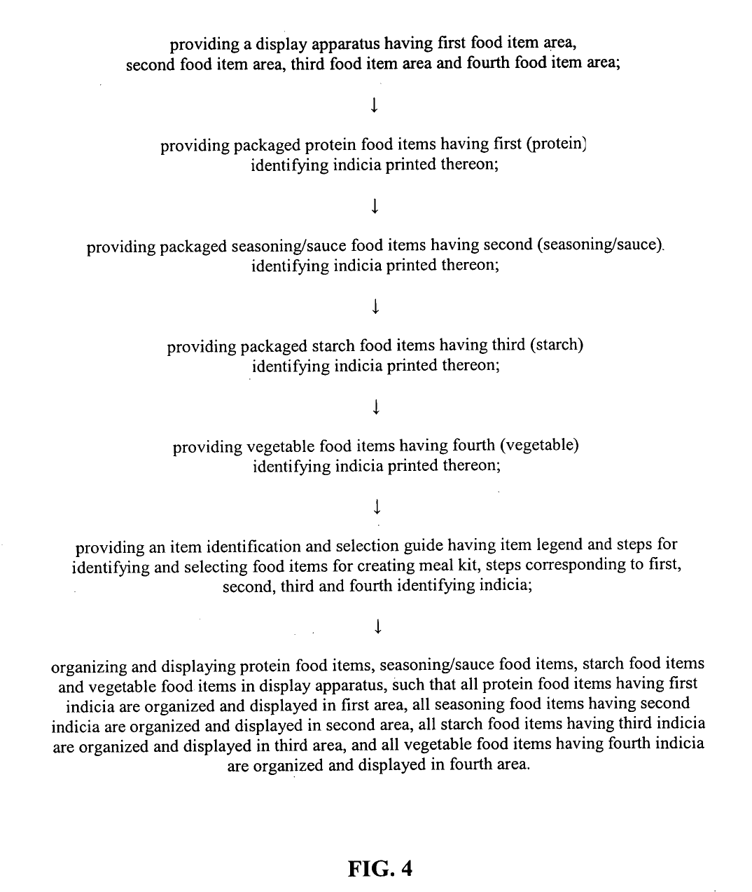

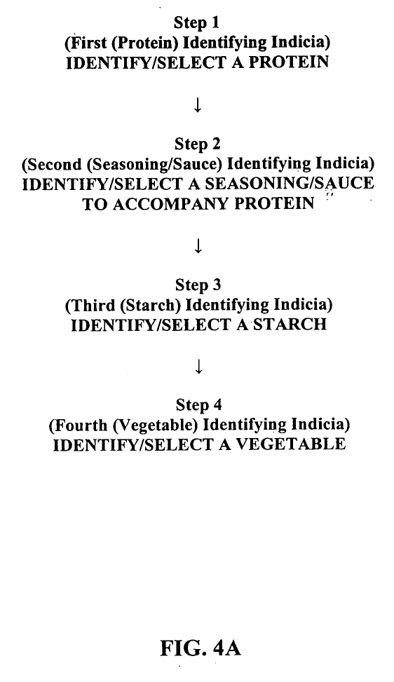

Having described embodiments of the display apparatus and packaged food and non-food items of the meal kit merchandising system, a description of a method of the present invention follows. With reference now to FIG. 4, a first method for merchandising (that is, organizing and displaying) items for a customized meal kit, comprises the steps of:
(1) providing a display apparatus having a first food item area, a second food item area, a third food item area and a fourth food item area;
(2) providing a first type of packaged food item (e.g., a protein) having a first (protein) identifying indicia printed thereon;
(3) providing a second type of packaged food item (e.g., a seasoning or sauce) having a second (seasoning or sauce) identifying indicia printed thereon;
(4) providing a third type of packaged food item (e.g., a starch) having a third (starch) identifying indicia printed thereon;
(5) providing a fourth type of packaged food item (e.g., a vegetable) having a fourth (vegetable) identifying indicia printed thereon;
(6) providing an item identification and selection guide comprising an item legend and representation of steps for identifying and selecting food items for creation of the meal kit, the steps corresponding to the first (protein) identifying indicia, the second (seasoning) identifying indicia, the third (starch) identifying indicia, and the fourth (vegetable) identifying indicia;
(7) organizing and displaying the first type of (protein) food items, second type of (seasoning or sauce) food items, third type of (starch) food items and fourth type of (vegetable) food items in the display apparatus, such that all of the first type of (protein) food items having the first indicia are organized and displayed in the first area, all of the second type of (seasoning or sauce) food items having the second indicia are organized and displayed in the second area, all of the third type of (starch) food items having the third indicia are organized and displayed in the third area, and all of the fourth type of (vegetable) food items having the fourth indicia are organized and displayed in the fourth area.

In this embodiment, the first (protein) identifying indicia comprises a first color, the second (seasoning) identifying indicia comprises a second color, the third (starch) identifying indicia comprises a third color, and the fourth (vegetable) identifying indicia comprises a fourth color. By organizing and displaying the protein, seasoning, starch and vegetable food items in the display apparatus by indicia (that is, color), the consumer can easily refer to the legend of item identification and selection guide 128 and to the color indicia printed on the item package and areas of the display apparatus, to identify the type of food item (i.e., protein, seasoning, starch or vegetable) to be selected for the meal kit. The identifying indicia may take a form other than a color, as described earlier in this disclosure.

FIG. 4A is a representation of the steps for identifying and selecting food items for the meal kit, as provided on item identification and selection guide 128. The steps are color-coded to correspond to the first (protein) identifying indicia, the second (seasoning) identifying indicia, the third (starch) identifying indicia, and the fourth (vegetable) identifying indicia. For discussion purposes, the first (protein) identifying indicia is black, the second (seasoning) identifying indicia is red, the third (starch) identifying indicia is yellow, and the fourth (vegetable) identifying indicia is green. Step 1 provides the instruction of IDENTIFY/SELECT A PROTEIN and is color-coded black to signify to the consumer that protein food items in the display apparatus bear a black indicia (and are located in the black area of the display apparatus), to assist in identification and selection of a protein food item. Step 2 provides the instruction of IDENTIFY/SELECT A SEASONING/SAUCE TO ACCOMPANY PROTEIN and is color-coded red to signify to the consumer that seasoning food items in the display apparatus bear a red indicia (and are located in the red area of the display apparatus), to assist in identification and selection of a seasoning food item. Step 3 provides the instruction of IDENTIFY/SELECT A STARCH and is color-coded yellow to signify to the consumer that starch food items in the display apparatus bear a yellow indicia (and are located in the yellow area of the display apparatus), to assist in identification and selection of a starch food item. Step 4 provides the instruction of IDENTIFY/SELECT A VEGETABLE to signify to the consumer that vegetable food items in the display apparatus bear a green indicia (and are located in the green area of the display apparatus), to assist in identification and selection of a vegetable food item.

Thus, following the steps of the item identification and selection guide of the method of the present invention, a consumer is able to create a customized meal by (1) identifying and selecting a protein food item from the black-colored packages, (2) identifying and selecting an accompanying seasoning/sauce from the red-colored packages, (3) identifying and selecting a starch from the yellow-colored packages and (4) identifying and selecting a vegetable from the green-colored packages.

As described above, other indicia may be provided on the packaging to assist in the identification and selection process. For example, indicia may be provided to convey information on the number of servings per container, serving suggestions, preparation instructions, the type of protein (e.g., chicken, beef or seafood), or the exact name of the food item (e.g., Maryland-style crab cakes).

While FIG. 4 describes providing four food items for a meal kit, and FIG. 4A describes four food item identification and selection steps, it should be understood by those skilled in the art that the method of the present invention may provide for more or less than four food items, and more or less than four food item identification and selection steps. For example, where the meal kit additionally comprises a beverage, soup, appetizer, dessert and/or non-food item, the method further comprises steps for providing such items and for identifying and selecting such items, through the use of additional indicia of the type of food item or non-food item provided. Similarly, where a consumer does not care to purchase one or more of the described four food items, the method provides for less than four food item identification and selection steps.

The method of the present invention also conveniently provides for a bag or container into which the selected food items (and non-food items) may be placed, to complete creation of the customized meal kit. The bag, with the components of the meal kit therein, can be taken to the counter for purchase and, optionally, to a food preparation and consumption station, to be discussed in more detail below.

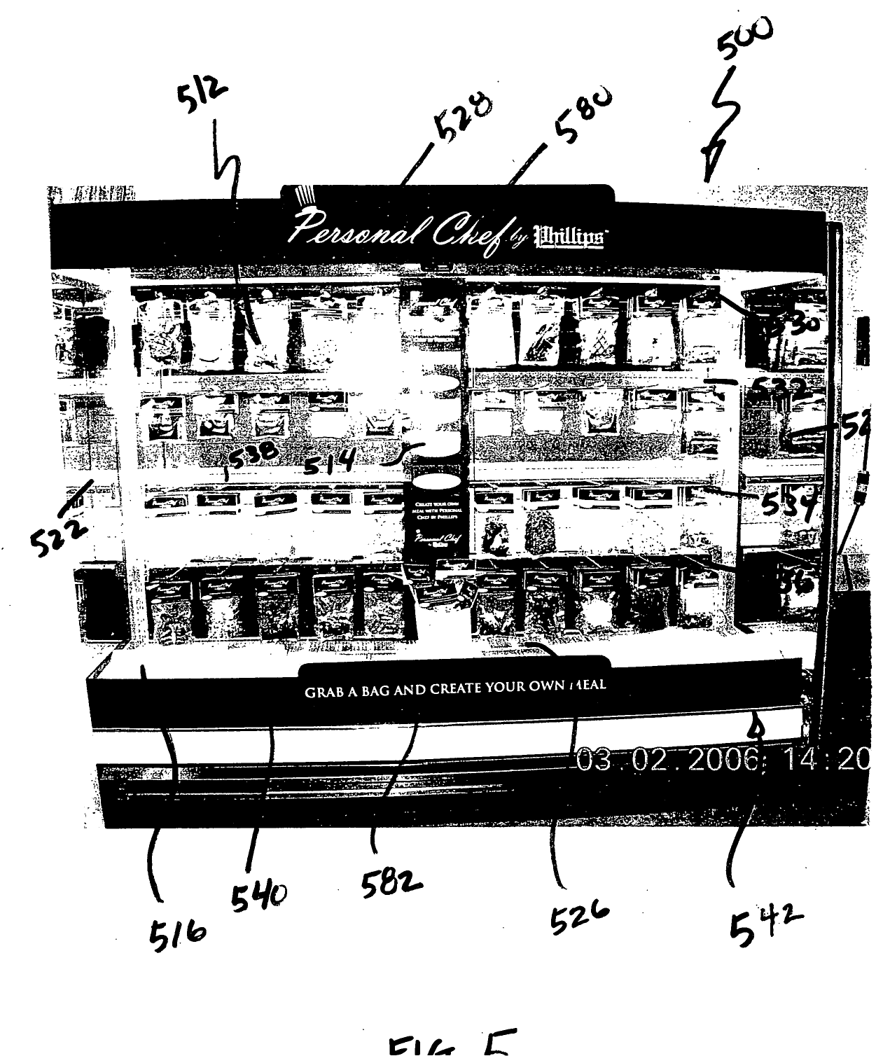

FIG. 5 shows an alternative embodiment of a meal kit merchandising system of the present invention. Display apparatus 500 comprises a refrigerated case 510, a plurality of packaged food items 512, an item identification and selection guide 514, and non food-items 516. Refrigerated case 510 comprises a back wall 518, a mirrored left-side wall 520, a mirrored right-side wall 522, a top 524 and a base 526. Top 526 comprises an upper merchandising banner 528 bearing a source identifier or trademark 580 for the merchandising meal kit system of the present invention. Naturally, other information may be provided on the merchandising banner, and the merchandising banner may be positioned anywhere along top 526 or on any other part of the refrigerator case.

In this embodiment, back wall 518 is sectioned into four rows or areas 530, 532, 534, 536, each containing a number of hooks or pegs 538. Each of the rows or areas is provided with an indicia (in this instance, color) to correspond to the type of packaged food item (to be described in more detail below) to be organized and displayed in each row. More particularly, row 530 is colored black for protein food items, row 532 is colored red for seasoning or sauce food items, row 534 is colored yellow for starch food items, and row 536 is colored green for vegetable food items. While back wall 518 has been sectioned into four rows or areas, it should be understood that the present invention contemplates for more or less rows depending on the number and types of food items to be organized and displayed in the refrigerator case. In addition, while back wall 518 has been sectioned into rows, it is envisioned that the back wall could be sectioned into columns, and such columns could be colored (or other indicia applied) to correspond to the type of food item to be organized and displayed in each column.

Base 526 of refrigerator case 510 is provided with a lower merchandising banner 540 bearing a tagline 582 or other merchandising information appropriate to the meal kit merchandising system of the present invention. Base 526 further includes an area 542 for receiving non-food or other food items of the invention. In this embodiment, take away bags 516 are provided in area 542 for use by the consumer in creation of a meal (discussed below).

Provided in the center of refrigerator case 510 is item identification and selection guide 514. Item identification and selection guide 514 is similar to item identification and selection guide 128 in that it comprises a food item legend and a representation of the steps for identifying and selecting food items for the meal kit.

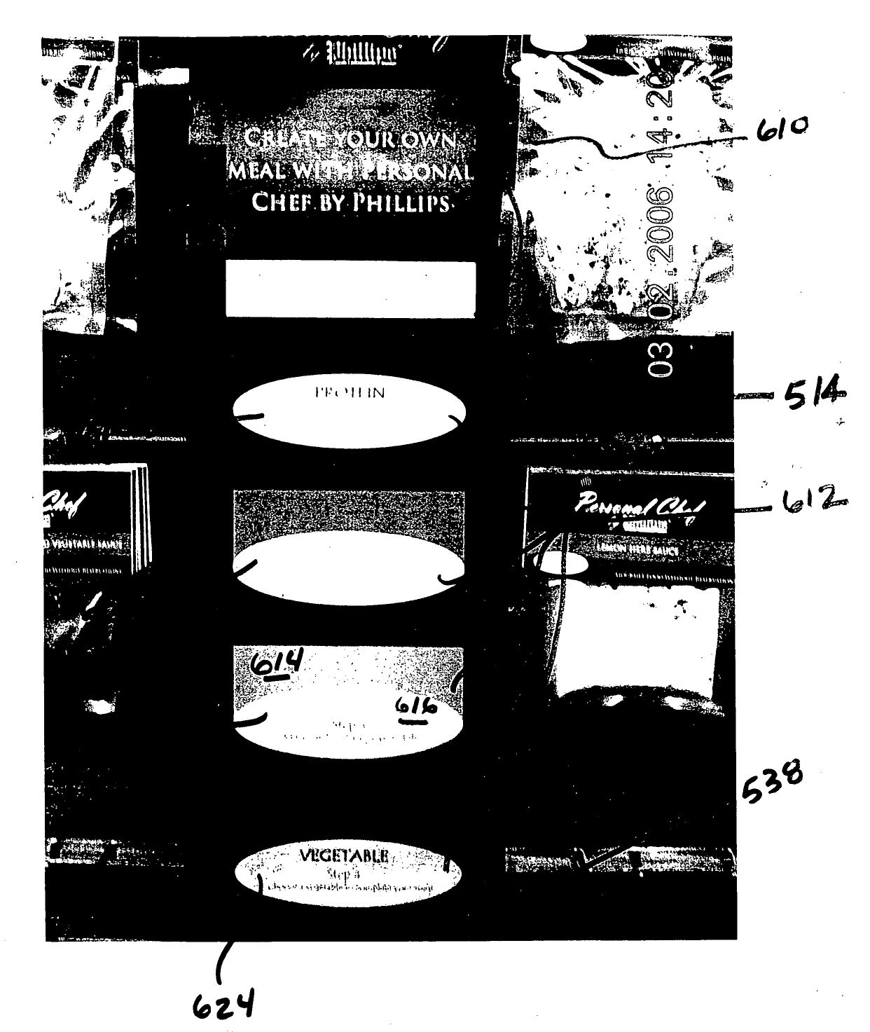

An enlarged view of item identification and selection guide 514 is shown in FIG. 6. Item identification and selection guide 514 includes an area 610 for merchandising information including source identifiers and trademarks, taglines, and instructional information for utilizing the meal kit system including, for example, “CREATE YOUR OWN MEAL WITH PERSONAL CHEF BY PHILLIPS” and “GRAB A BAG TO CREATE A MEAL AND FOLLOW THESE EASY STEPS”. Of course, other instructions or information may be provided in area 610 to convey the same to the consumer.

Item identification and selection guide 514 further comprises the steps of the method for creating the meal kit of the present invention. In this embodiment, four steps are shown, each step being represented by a step indicia 612 comprising a color element 614 and a step identifier and instruction oval 616. In Step 1, identified as 618, the color element is black to correspond to food packages containing protein food items and to row 530 of the refrigerator case, and the step identification and instructional oval contains the instruction “PROTEIN Step 1 Choose your protein”.

In Step 2, identified as 620, the color element is red to correspond to food packages containing seasoning or sauce food items and to row 532 of the refrigerator case, and the step identification and instructional oval contains the instruction “SAUCE Step 2 Select a sauce for your protein”. In Step 3, identified as 622, the color element is yellow to correspond to food packages containing starch food items and to row 534 of the refrigerator case, and the step identification and instructional oval contains the instruction “STARCH Step 3 Add a starch to balance your dish”. In Step 4, identified as 624, the color element is green to correspond to food packages containing vegetable food items and to row 536 of the refrigerator case, and the step identification and instructional oval contains the instruction “VEGETABLE Step 4 Choose a vegetable to complete your meal”.

Naturally, other information, instructions, shapes and colors (or indicia) may be used on item identification and selection guide 514, such as that discussed above with respect to item identification and selection guide 128, as appropriate. Moreover, while item identification and selection guide 514 is shown in the center section of refrigerator case 510, it may be positioned in any other suitable location, so long as it is within view of the consumer.

As stated above, a plurality of packaged food items 512 are organized and displayed in refrigerator case 510. In the embodiment of FIG. 5, the plurality of food items comprises protein food items in row 530, seasoning or sauce food items in row 532, starch food items in row 534 and vegetable food items in row 536.

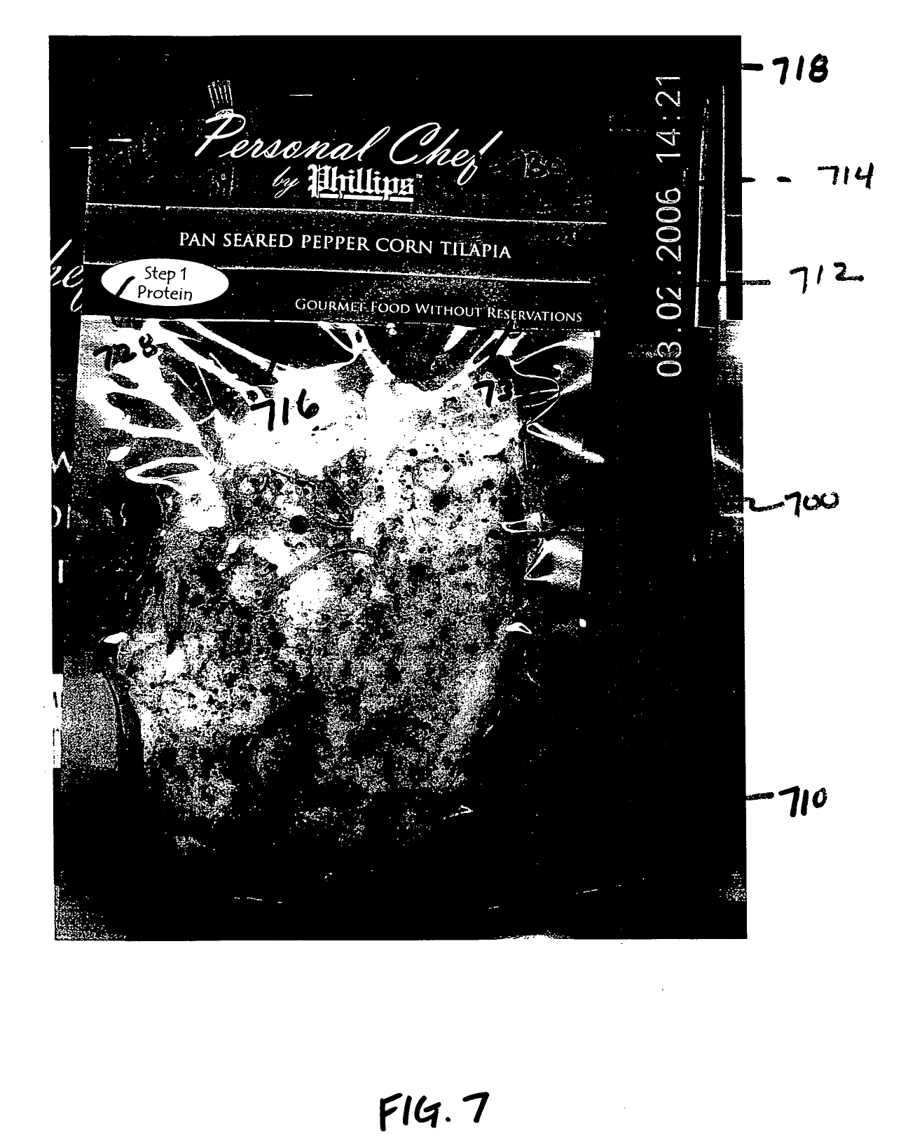

An enlarged view of a packaged food item is shown in FIG. 7 at 700. While a protein food item is shown in FIG. 7, the packaging elements thereof are common to all of the types of food items. More particularly, packaged food item 700 comprises a sealed food item containing bag 710, a labeling cuff 712 and a clear plastic hanger 718. In the embodiment of FIG. 5, all of the food items of the meal kit are prepared and processed to extend the shelf-life thereof by application of hydrostatic pressure, in accordance with the method of the application to Love et al. This food processing method provides for an oxygen-permeable, vacuum-sealable bag, preferably, the Cryovac® HP2700 bag. This same bag is preferred for food item containing bag 710, as it effectively preserves the freshness, taste, texture, color and quality of the packaged prepared food item for an extended period of time, while eliminating bacteria and microorganisms harmful to the consumer. It should be noted by those skilled in the art that other food processing and packaging bag systems are envisioned for food item containing bag 710 of the present invention.

Returning to FIG. 7, food item containing bag 710 has an upper edge 714 covered by a labeling cuff 712 affixed by known means (e.g., adhesive or staples). Labeling cuff 712 comprises a cardboard blank 716 that is folded over upper edge 714 to form a front side 720 and a back side 722 (not shown). Front side 720 of labeling cuff 712 comprises a first front-side type of food item indicia 724, a second front-side food item name indicia 726, a third front-side food type selection step indicia 728, and first and second source identifier or trademark indicia 730,732. Like first front-side indicia 218 of item package 200, first front-side type of food item indicia 724 is a colored band having a width of approximately one inch that extends from the left side of food item package 700 to the right side. In this embodiment, indicia 724 is colored to correspond to a type of food item, so that each type of food item has its own specific color. Item package 700 contains a protein food item, so indicia 724 is colored black to indicate that the food item contained therein is a protein food item, and to correspond with row 530 of refrigerated display case 510 and Step 1, identified as 618, of item identification and selection guide 514.

Second front-side food item name indicia 726 comprises textual matter or alpha characters to identify the exact name of the food item sealed within the item package. In the packaged food item of FIG. 7, second front-side indicia indicates that the name of this particular type of protein food item is “PAN SEARED PEPPER CORN TILAPIA”. Below and to the left of food item name indicia 726 is third front-side food type selection step indicia 728. Indicia 728 is shaped and colored to correspond to the step identifier and instruction oval 616 of item identification and selection guide 514. Thus, third front-side food type selection step indicia 728 is oval-shaped and similarly colored, to assist the consumer in matching the steps on the item identification and selection guide to the selection step indicia on the food item packages. Because the food item of FIG. 7 is a protein, food type selection step indicia 728 contains the information “Step 1 Protein”. By referring to this indicia, the consumer knows that this type of food item is a protein that corresponds to and complies with the first step of the method for creating the customized meal of the present invention. Obviously, the information printed within food type selection step indicia 728 varies depending on the type of food item contained within the food package.

Source identifier or trademark indicia 730,732 is positioned at the top and bottom of the labeling cuff and comprises both a stylized trademark and a tagline. It should be realized by those skilled in the merchandising art that the source identifier and trademark indicia may be placed in other areas of the labeling cuff. It should be further understood that other indicia, such as those described with respect to the front side 210 food package 200, may be provided on the front side of package 700.

While back side 722 is not shown, it should be realized that any of the indicia described with respect to back side 310 of item package 200 may be printed on back side 722 to convey information to the consumer. Moreover, back side 722 of labeling cuff 712 need not be the same configuration of the front side of the cuff. For example, if more space is required to print information on the back side of the label, the total size of the cardboard blank could be lengthened to accommodate the indicia and information to be printed thereon.

It is also envisioned that the objectives of the present invention could be accomplished with a separate labeling component. Indeed, the indicia of the food packages could be printed directly on the front and back sides of the food item containing bag 710, utilizing inks suitable for use with food items. It is also envisioned that the indicia could be printed on adhesive, front- and/or back-side labels that are simply adhered to the front- and/or back- side of food item containing bag 710.

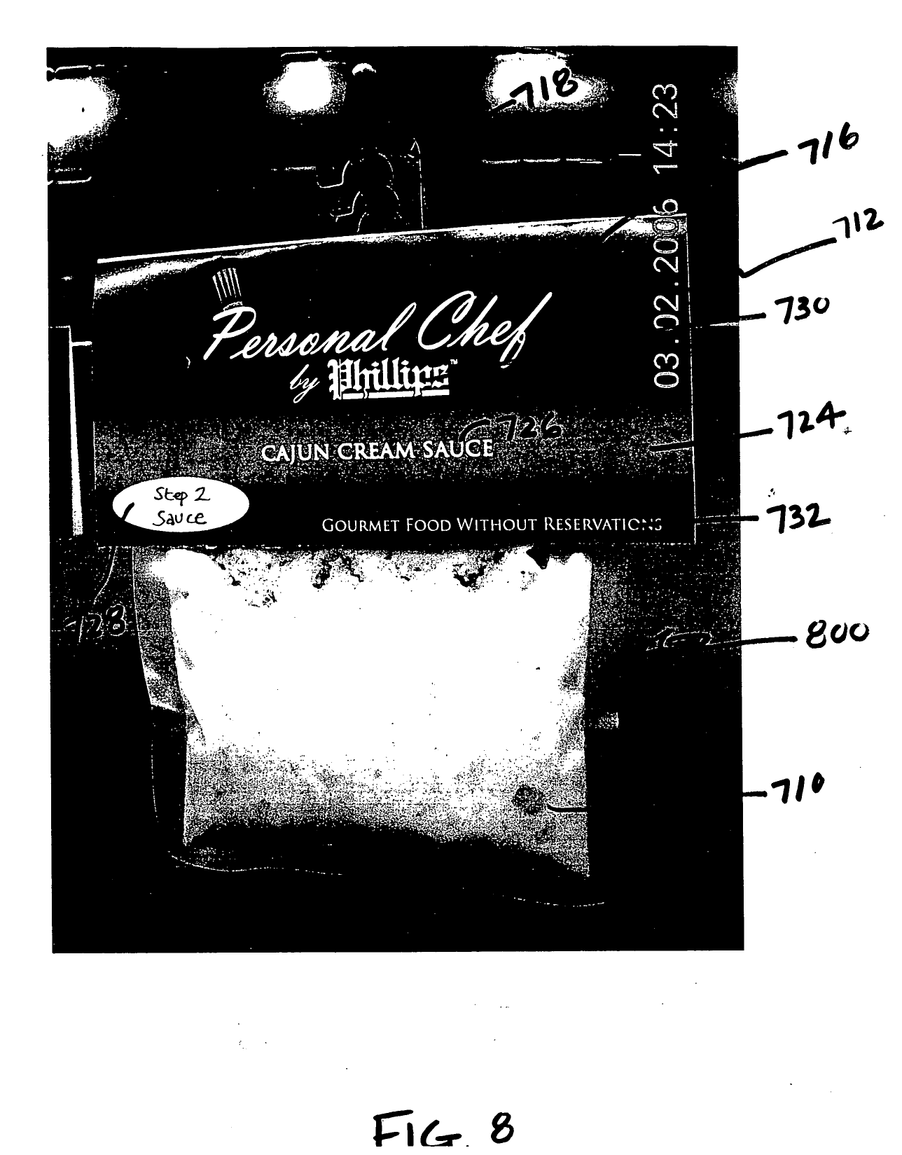

FIG. 8 shows a food item package 800 for a seasoning or sauce type of food item. Because the food item type is a seasoning or sauce, first front-side type of food item indicia 724 is colored red to indicate that the food item contained therein is a seasoning or sauce type of food item, and to correspond with row 532 of refrigerated display case 510 and Step 2, identified as 620, of item identification and selection guide 514.

Second front-side food item name indicia 726 indicates that the name of this particular type of seasoning or sauce food item is CAJUN CREAM SAUCE. Because the food item of FIG. 8 is a seasoning or sauce, food type selection step indicia 728 contains the information “Step 2 Sauce”. By referring to this indicia, the consumer knows that this type of food item is a seasoning or sauce that corresponds to and complies with the second step of the method for creating the customized meal of the present invention.

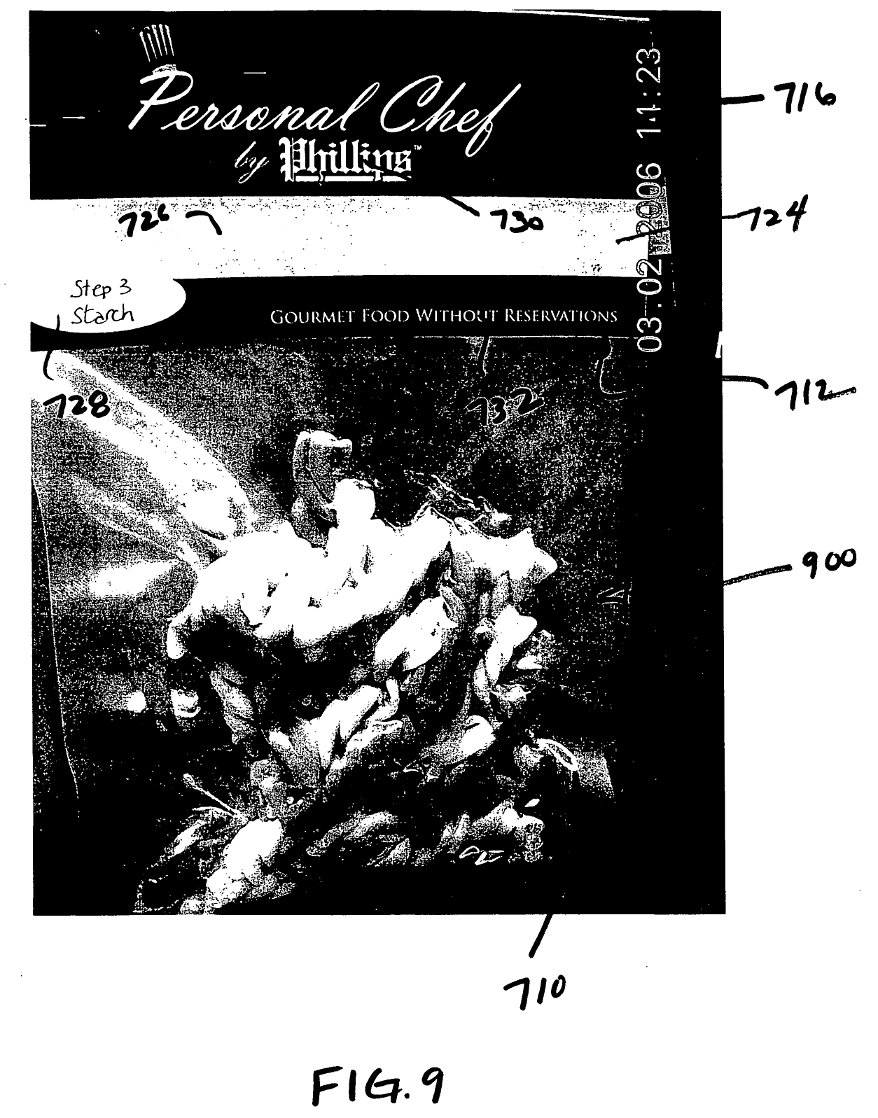

FIG. 9 shows a food item package 900 for a starch type of food item. Because the food item type is a starch, first front-side type of food item indicia 724 is colored yellow to indicate that the food item contained therein is a starch type of food item, and to correspond with row 534 of refrigerated display case 510 and Step 3, identified as 622, of food item identification and selection guide 514.

Second front-side food item name indicia 726 indicates that the name of this particular type of starch food item is TRI COLORED FUSSILI. Because the food item of FIG. 9 is a starch, food type selection step indicia 728 contains the information “Step 3 Starch”. By referring to this indicia, the consumer knows that this type of food item is a starch that corresponds to and complies with the third step of the method for creating the customized meal of the present invention.

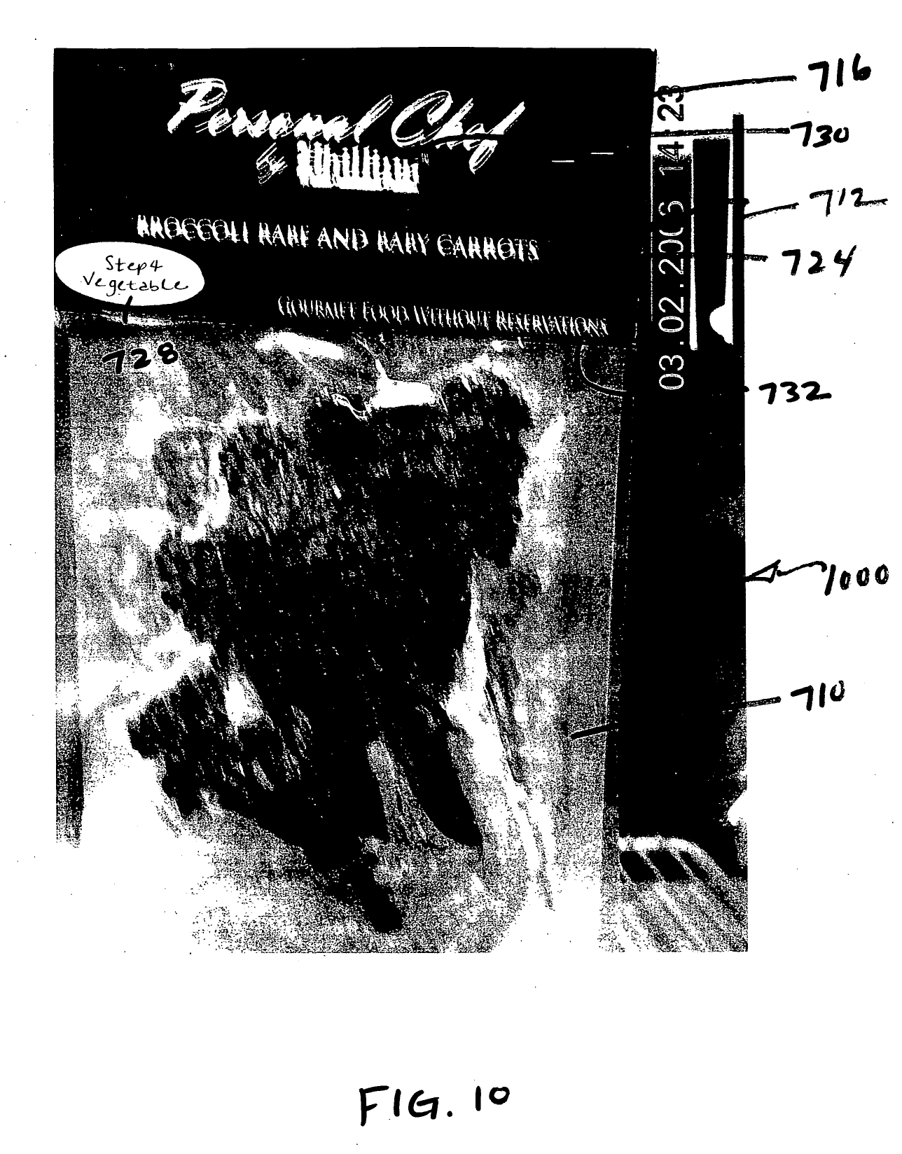

FIG. 10 shows a food item package 1000 for a vegetable type of food item. Because the food item type is a vegetable, first front-side type of food item indicia 724 is colored green to indicate that the food item contained therein is a vegetable type of food item, and to correspond with row 536 of refrigerated display case 510 and to Step 4, identified as 624, of food item identification and selection guide 514.

Second front-side food item name indicia 726 indicates that the name of this particular type of vegetable food item is BROCCOLI RABE AND CARROTS. Because the food item of FIG. 10 is a vegetable, food type selection step indicia 728 contains the information “Step 4 Vegetable”. By referring to this indicia, the consumer knows that this type of food item is a vegetable that corresponds to and complies with the fourth step of the method for creating the customized meal of the present invention.

Having described the meat kit merchandising system of FIG. 5, the consumer approaches refrigerated case 510, selects a take-away bag 516 and follows the steps on the item identification and selection guide 514 to identify and select, if desired, a protein food item, a seasoning or sauce food item, a starch food item and a vegetable food item. The food items, which are easily identifiable and selectable by the consumer by all of the indicia printed on the food packages and the item identification and selection guide, are put into the take-away bag to create a complete meal for purchase and consumption by the consumer. FIG. 11 shows take-away bag 516 with a protein food item 1110, a seasoning or sauce food item 1112, a starch food item 1114 and a vegetable food item 1116 contained therein.

FIG. 12 is an illustration of display apparatus 100 of FIG. 1 in a retail or other environment where food could conceivably be selected, purchased, prepared and/or consumed as a meal. In this figure, display apparatus 100 is positioned in a food preparation and service station 1200 located in a retail establishment, for example, a grocery store. It is envisioned that this same food preparation and service station could be located in the eatery of a mall, a vending machine area, a gas station or convenience store, in a college dining hall, or even in the take-out or other area of a restaurant.

A non-food item display rack 1210 is shown disposed on a food preparation surface 1212. Display rack 1210 contains the non-food items of the invention, for example, the take-away bag, eating utensils, heating and serving trays, cellophane wrapping, napkins, etc. Food preparation surface 1212 is preferably a table or other flat surface that provides a space for preparation and cooking of the food items selected from display apparatus 100. A waste receptacle 1214 is provided in the vicinity of food preparation surface 1212 to allow the consumer to dispose of the packaging for the selected item(s) of the meal. To the extent that the selected items are sub-par cooked or require heating, a microwave oven 1216 is also provided to heat/cook the items for immediate consumption. Microwave oven 1216 may be pre-programmed with the recommended cooking times and temperatures for each item displayed in display apparatus 100. To heat the food item, the consumer simply selects the button on panel 1218 that corresponds to the food item to be heated. After preparing and heating all selected food items of the meal, the consumer can consume the meal at a nearby table and seating area 1220 or take the meal to another location for consumption. While FIG. 12 shows display apparatus 100 positioned within food preparation and service station 1200, it is envisioned that display apparatus 500 could also be employed in a food preparation and service station.

Moreover, while display apparatus 500 shows the types of food items in separate food packages and organized and displayed in different rows, the present invention also contemplates that two or more types of food items could be individually packaged, but grouped together under a single labeling cuff for selection and purchase by the consumer. For example, a pre-selected protein, starch and vegetable may be grouped by the manufacturer to merchandise a complete meal to the consumer, where the flavors and textures thereof compliment each other to create a harmonious meal.

In still another embodiment, two or more ingredients of a single dish could be separately packaged and grouped together under a single labeling cuff for selection and purchase by the consumer. For example, a stock or base, shucked oysters and vegetables could be separately packaged, but grouped together by the manufacturer, to merchandise a fresh, oyster stew kit.

In yet another embodiment of the invention, “themed” or ethnic protein, seasoning, starch and vegetable food items (e.g., Mexican, Asian or Italian) could be organized and displayed in separate display cases, to permit the creation of customized themed or ethnic meals. It is also envisioned that family-sized packages of the various food items could be organized and displayed in a separate display apparatus, rather than being organized and displayed in a display apparatus containing other sized packages.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor, and thus, are not intended to limit the present invention and the appended claims in any way.

What is claimed is:

1. A merchandising method for the organization and display of items for creating a customized meal kit, the method comprising the steps of:
(a) providing a display apparatus;
(b) providing packaged protein food-items, the protein food items having a first indicia of the type of food item imprinted thereon;
(c) providing packaged starch food items, the starch food items having a second indicia of the type of food item imprinted thereon;
(d) providing packaged vegetable food items, the vegetable food items having a third indicia of the type of food item imprinted thereon;
(e) providing an item identification and selection guide for creating the meal kit and having a representation of steps for identifying and selecting the food items for the meal kit, the steps corresponding to the first indicia of the protein food items, the second indicia of the starch food items, and the third indicia of the vegetable food items; and
(f) organizing and displaying the protein food items, starch food items and vegetable food items in the display apparatus, such that all of the protein food items having the first indicia are displayed in a first area of the display apparatus, all of the starch food items having the second indicia are displayed in a second area of the display apparatus, and all of the vegetable food items having the third indicia are displayed in a third area of the display apparatus.

2. The method of claim 1, wherein the first indicia of the protein food items comprises a first color, the second indicia of the starch food items comprises a second color, and the third indicia of the vegetable foods items comprises a third color.

3. The method of claim 2, wherein the representation of steps for identifying and selecting the items for the meal kit further corresponds to the first color, second color and third color of the first indicia, second indicia and third indicia.

4. The method of claim 3, wherein the first area of the display apparatus is colored to correspond to the first color of the first indicia, the second area of the display apparatus is colored to correspond to the second color of the second indicia, and the third area of the display apparatus is colored to correspond to the third color of the third indicia.

5. The method of claim 4, wherein the first, second and third areas of the display apparatus are arranged horizontally.

6. The method of claim 1, wherein the first area of the display apparatus has a first area indicia corresponding to the first indicia of the protein food items, the second area of the display apparatus has a second area indicia corresponding to the second indicia of the starch food items, and the third area of the display apparatus has a third area indicia corresponding to the third indicia of the vegetable food items.

7. The method of claim 6, wherein the first, second and third areas of the display apparatus are arranged horizontally.

8. The method of claim 1 further comprising the step of providing packaged seasoning food items, the seasoning food items having a fourth indicia of the type of food item imprinted thereon.

9. The method of claim 8, wherein the representation of steps of the item identification and selection guide further corresponds to the fourth indicia of the seasoning food items.

10. The method of claim 9 further comprising the step of organizing and displaying the seasoning food items in the display apparatus, such that all of the seasoning food items having the fourth indicia are displayed in a fourth area of the display apparatus.

11. The method of claim 10, wherein the fourth area of the display apparatus has a fourth area indicia corresponding to the fourth indicia of the seasoning food items.

12. The method of claim 11, wherein the steps for identifying and selecting the food items for the meal kit comprise:
(a) identifying a protein food item by referring to the first indicia imprinted on the protein food item and the item identification and selection guide;
(b) selecting a protein food item;
(c) identifying a seasoning food item by referring to the fourth indicia imprinted on the seasoning food item and the item identification and selection guide;
(d) selecting a seasoning food item;
(e) identifying a starch food item by referring to the second indicia imprinted on the starch food item and the item identification and selection guide;
(f) selecting a starch food item;
(g) identifying a vegetable food item by referring to the third indicia imprinted on the vegetable food item and the item identification and selection guide; and
(h) selecting a vegetable food item.

13. The method of claim 12 further comprising the step of providing a bag into which the selected food items may be placed.

14. The method of claim 1 further comprising the step of providing bags into which selected protein food items, starch items and vegetable food items may be placed for purchase.

15. A merchandising method for the organization and display of items for creating a customized meal kit, the method comprising the steps of:
(a) providing a display apparatus;
(b) providing a plurality of types of food items, each of said types of food items having indicia of the types of food items printed thereon;
(c) providing an item identification and selection guide for creating the meal kit and having a representation of steps for identifying and selecting types of food items from the plurality of types of food items, the steps corresponding to the indicia of the types of food items;
(d) organizing and displaying the plurality of types of food items in the display apparatus.

16. The method of claim 15, wherein the plurality of types of food items comprises protein food items, seasoning food items, starch food items and vegetable food items.

17. The method of claim 16, wherein the indicia of the types of food items comprises a protein food item indicia, a seasoning food item indicia, a starch food item indicia and a vegetable food item indicia.

18. The method of claim 17, wherein the protein food item indicia is a first color, the seasoning food item indicia is a second color, the starch food item is a third color and the vegetable food item is a fourth color.

19. The method of claim 18, wherein the steps for identifying and selecting types of food items from the plurality of types of food items, comprises the steps of:
(a) identifying and selecting a protein food item;
(b) identifying and selecting a seasoning food item;
(c) identifying and selecting a starch food item; and
(d) identifying and selecting a vegetable food item.

20. The method of claim 19 further comprising the step of providing a bag into which the identified and selected food items are placed to customize and complete the meal kit.

21. A meal kit merchandising system, comprising:
a display apparatus;
at least two types of packaged food items, the first type of food item having a first type of food item indicia for identifying the first type of food item and the second type of food item having a second type of food item indicia for identifying the second type of food item; and
a food item identification and selection guide for identifying and selecting at least one of the at least two types of packaged food items to create the meal kit.

22. The system of claim 21, wherein the first type of food item indicia is a first color and the second type of food item indicia is a second color.

23. The system of claim 22, wherein the display apparatus is sectioned into at least a first section and a second section, the first type of food item being positioned in the first section and the second type of food item being positioned in the second section.

24. The system of claim 23, wherein the first section of the display apparatus comprises a first section indicia of a first color, and the second section of the display apparatus comprises a second section indicia of a second color.

25. The system of claim 24, wherein the first color of the first type of food item indicia is the same as the first color of the first section indicia, and the second color of the second type of food item indicia is the same as the second color of the second section indicia.

26. The system of claim 21, wherein the food item identification and selection guide provides a legend for the first type of food item indicia and the second type of food item indicia, to assist the consumer in identification and selection of the types of food items.

27. The system of claim 26, wherein the food item identification and selection guide further comprises a representation of steps for identifying and selecting the types of food items to create a customized meal.

28. The system of claim 21 further comprising a take-away container into which the identified and selected types of food items may be placed.

29. The system of claim 28, wherein the display apparatus is positioned within a food preparation and service station.
